(19) United States
(12) Patent Application Publication
(10) Pub. No.: US 2006/0147876 A1
(43) Pub. Date: Jul. 6, 2006

(54) Apparatus for shaping a dental model

(76) Inventor: Vadim Firdman, Brooklyn, NY (US)

Correspondence Address: Vadim Firdman, 1607 Sheepshead Bay Rd., Brooklyn, NY, 11235, US

(21) Appl. No.: 11/028,930

(22) Filed: Jan. 4, 2005

(51) Int. Cl. A61C 19/00

(52) U.S. Cl. 433/32

(57) ABSTRACT

An apparatus for shaping waxed bite blocks for full or partial dentures having a case, a hot plate surface and a heating element. The case includes at least two forwardly inclined side walls and a back wall. The hot plate surface is hingedly connected to the case such that the hot plate surface can be opened and closed. The heating element is positioned inside the case immediately below the hot plate surface such that when the heating element is activated, it heats the hot plate surface. In its closed position, the hot plate surface rests securely on the side walls of the case, while being downwardly forwardly inclined.

### FIELD OF THE INVENTION

The present invention relates to an apparatus for shaping waxed bite blocks for full or partial dentures.

### BACKGROUND OF THE INVENTION

To accurately form and position false teeth or caps, a dentist normally makes a negative impression of the affected tooth or teeth. The negative impression may be partial, unilateral or bilateral, depending upon the extent of work to be done; the negative impression serves as a mold for developing a die of the patient's tooth or teeth. The negative impression is obtained by partially filling a tray with thermoplastic material. The filled tray is inserted within the patient's mouth such that the teeth and adjacent gum sink into and create a cavity within the thermoplastic material. Shortly thereafter, the thermoplastic material will cure and retain an exact impression of the patient's teeth and adjacent gum. This is an essentially standard technique presently used by most dentists.

To form a tooth die, a pourable casting stone, known as pink stone is poured into the negative impression up to at least the margin or base of the tooth. The pink stone is compacted to preclude voids and remove any air bubbles. After the pink stone is at least partially cured, wax or similar lubricant is swathed upon the surface of the pink stone to form the bite block.

The waxed bite block is then sent back to the dentist who shapes and trims the bite block to ensure that the resulting denture will fit the patient. Particularly, the shape and height of each wax tooth of the bite block is often reshaped in accordance with patient's individual measurements.

Presently, shaping knives and plates are used to shape waxed bite blocks for full or partial dentures. Knives and plates are heated by a small hand-held torch with an open flame and then applied to the wax surface of each tooth to be shaped. Application of the hot shaping device causes the excess wax to melt. The melted wax then has to be collected in a separate collector in a way that would protect dentist's hands and all surfaces from this hot melting wax.

Accordingly, there is a need in the art for a more convenient and safe way to shape waxed bite blocks for full or partial dentures.

### SUMMARY OF THE INVENTION

In one of its aspects, the present invention provides an apparatus for shaping waxed bite blocks for full or partial dentures having a case, a hot plate surface and a heating element. The case includes at least two forwardly inclined side walls and a back wall. The hot plate surface is hingedly connected to the case such that the hot plate surface can be opened and closed. The heating element is positioned inside the case immediately below the hot plate surface such that when the heating element is activated, it heats the hot plate surface. In its closed position, the hot plate surface rests securely on the side walls of the case, while being downwardly forwardly inclined.

In another aspect, the apparatus also includes a drawer located at the bottom of the case. The drawer can be selectively pulled out of the case. The drawer can be provided with a liner protecting the drawer's surface from hot wax.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 shows a front perspective view of the shaping apparatus in accordance with the preferred embodiment of the invention.

FIG. 2 shows a partially cut-out perspective view of the shaping apparatus shown in FIG. 1.

FIG. 3 shows a partially cut-out side view of the shaping apparatus shown in FIG. 1.

### DETAILED DESCRIPTION OF THE PREFERRED EMBODIMENTS AND DRAWINGS

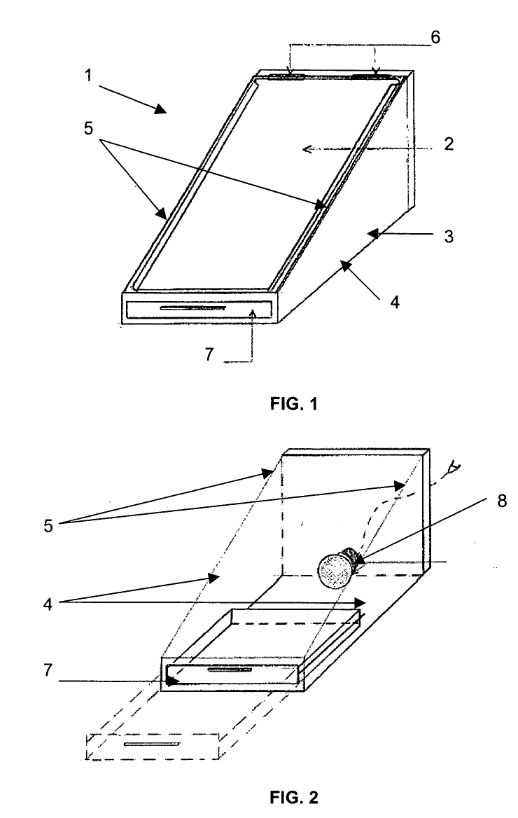

As shown in FIG. 1, in accordance with the present invention an apparatus 1 for shaping waxed bite blocks for full or partial dentures includes a hot plate surface 2 hingedly connected to the case 3. Hot plate surface 2 is preferably made of metal. Case 3 preferably has triangular walls 4 with forwardly inclined upper edges 5. Hot plate surface 2 is connected to case 3 with hinges 6 (or any other appropriate connectors) such that the hot plate surface can be selectively opened or closed. Walls 4 and their upper edges 5 are preferably shaped in way that allows for the hot plate surface 2 to rest securely on the edges 5 while being downwardly forwardly inclined in the closed position.

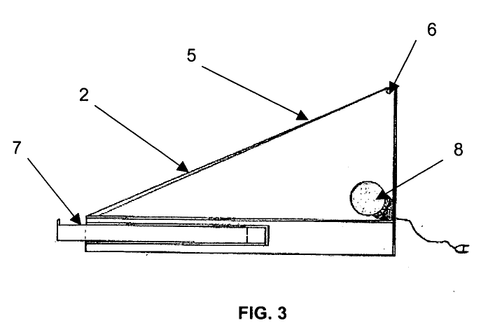

Case 3 is preferably hollow inside and has a heating device 8 (schematically shown in FIGS. 2 and 3 as a lightbulb) secured to the back wall of the case. The heating device is located immediately below the hot plate surface and heats the hot plate surface when activated. When the heating device 8 includes a cord to be connected to an outside electrical supply line, the cord protrudes through the back wall. As will be appreciated by a person skilled in the art, the heating device 8 can also be battery operated. A non-electrical heating device may also be utilized.

A drawer 7 may be provided in the lower portion of case 3, as shown in FIGS. 1-3. The drawer may be selectively opened or closed by the user of the apparatus by sliding the drawer in and out of the case 3. The drawer may be lined with a liner protecting its surface from hot wax.

In operation, the user will turn on the heating element and open the lined drawer before starting to shape a waxed bite block. When the hot plate surface is heated to a required temperature, the user will start shaping the bite block in accordance with individual measurements of a patient. Because of the surface inclination of the hot plate surface, the melted wax will flow downwardly along the hot plate surface and into the open lined drawer. When bite block shaping is completed, the heating element may be turned off and the drawer liner with the accumulated wax can be removed from the drawer. Thus, the provided apparatus is safe in operation and is easy to clean up and store.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

I claim as follows:

1. An apparatus for shaping waxed bite blocks for full or partial dentures comprising:
a case, having at least two forwardly inclined side walls and a back wall;
a hot plate surface hingedly connected to said case such that said hot plate surface is selectively movable between an open and close positions; and
a heating element positioned inside said case immediately below said hot plate surface,
wherein when said heating element is activated, it heats said hot plate surface; wherein when said hot plate surface is selectively moved into its close position, said hot plate surface rests securely on said side walls of said case, and wherein said hot plate surface is downwardly forwardly inclined in its close position.

2. The apparatus according to claim 1, further comprising a drawer located at the bottom of said case, said drawer being selectively slidable out of said case.

3. The apparatus according to claim 2, wherein said drawer further comprises a wax protection liner.

4. The apparatus according to claim 2, wherein said heating element is located on said back wall of said case and wherein said heating element further comprises an activation mechanism protruding through said back wall of said case.

5. The apparatus according to claim 2, wherein said heating element is a lightbulb.
